(19) United States
(12) Patent Application Publication
(10) Pub. No.: US 2003/0120938 A1
(43) Pub. Date: Jun. 26, 2003

(54) Method of securing software against reverse engineering

(76) Inventor: Miki Mullor, Irvine, CA (US)

Correspondence Address: VENABLE, BAETJER, HOWARD AND CIVILETTI, LLP, P.O. BOX 34385, WASHINGTON, DC, 20043-9998, US

(21) Appl. No.: 10/300,905

(22) Filed: Nov. 21, 2002

Related U.S. Application Data
(60) Provisional application No. 60/333,592, filed on Nov. 27, 2001.

(51) Int. Cl. H04L 9/32

(52) U.S. Cl. 713/190

(57) ABSTRACT

A method of securing software against reverse engineering replaces portions of software code with tokens. A key is created in which the functionality of each such token is indicated. The key is stored in memory, separate from the software. The key may be encrypted for added security. When an authorized user seeks to run the software, the key is recalled from memory and decrypted, if previously encrypted. The corresponding functionalities indicated by the key are substituted in the software whenever tokens are encountered.

### CROSS-REFERENCE TO RELATED APPLICATION

This application is based upon and is entitled to the priority date of U.S. Provisional Application No. 60/333,592, filed on Nov. 27, 2001, and incorporated by reference herein in its entirety.

### BACKGROUND OF THE INVENTION

1. Field of the Invention

This invention relates to the field of software security. More specifically, it relates to protecting software from unauthorized use and from unauthorized analysis or modification, including reverse engineering.

2. Discussion of Related Art

Unauthorized software use, or software piracy, has cost software producers and distributors billions of dollars worldwide. Consequently, there have been a number of methods developed to prevent software piracy. One of the early approaches was to use various schemes to prevent copying of software. This was not popular with legitimate users, who wished to make backup copies. Further, these anti-copy schemes were based on methods that were so simple that programs were developed and sold that disabled the anti-copy mechanisms, thereby allowing unlimited copying.

FIG. 1 depicts an example of a software program 100. Program 100 may be comprised of unprotected code 101 that is allowed to execute with no need to obtain specific authorization and of protected code 102 that requires specific authorization from the software maker to run, usually obtained in a monetary transaction. Authorization may be granted in form of a software license.

FIG. 2A describes prior art authorization logic for a software program 100 comprised of a code structure as depicted in FIG. 1. In this example, program 100 will attempt to authorize itself to execute protected code 102. In step 104 a shared secret is loaded into volatile memory. Shared secret is preferably encrypted and stored separately from the program 100. Its presence in the volatile memory authorizes use of protected code 102. Comparing step 105 sets up a verification structure in memory that contains the shared secret and compares it to an original shared secret embedded in the code by the software manufacturer. If the comparison in step 105 determines lack of a match, the logic will be directed to display rejection message to user 106, which will lead to termination of the execution of program 100. If the comparison in step 105 determines that there is a match, this will result in the logic proceeding to step 107 (Continue), which results in protected code 102 being executed. A possible attack by a hacker would be to locate decision block 105 and alter the code to bypass it and resume execution 107 without having a key present to authorize the execution.

An apparent solution, with some real security, might come from using technology developed for encrypting text. Executable software can be treated as binary text and encrypted using this well-known technology. The problem is that such encrypted software can not execute or run. The only way to run it is to decrypt it back to its original form. Of course, once that is done, it can be copied or pirated. An example of a system using such technology may be found, for example, in U.S. Pat. No. 5,892,900 to Ginter et al.

FIG. 2B depicts an example of prior art authorization and protection logic for a software program 100 comprised of a code structure as outlined in FIG. 1, where protected code 102 is encrypted with a cryptographic key. Presence of cryptographic key in volatile memory will authorize use of protected code 102. In this prior art scheme, comparing step 110 checks for the existence of a key. Failure to locate a key will result in termination of the application in step 113. A successful comparison in step 110 will result in decryption of protected code 102 with the key and resumption of execution of decrypted code 102. A possible attack on this approach would be to capture decrypted code 102 right after decryption process 111 and to store it in a file. This attack will render redundant the use of the decryption key, resulting in possible unauthorized access to protected code 102.

U.S. Pat. No. 6,192,475 to Wallace teaches a system and method of protecting software against unauthorized use and reverse engineering. Specifically, Wallace teaches the manipulation of data memory locations (pointers manipulation).

It would be desirable to have a new method of self-validation for protected applications that is not dependent on decision blocks for its security and in which the code is executable and does not use encryption for protecting it from reverse engineering.

### SUMMARY OF THE INVENTION

An objective of this invention is to provide a method to prevent unauthorized use of software and to protect the software against reverse engineering. Hackers use reverse engineering of software to discover how software is protected in order to neutralize that protection and thereby gain access to the software.

In one basic embodiment of the invention, a method of securing software against reverse engineering replaces portions of software code with tokens. A key is created in which the functionality of each such token is indicated; that is, the key is a look-up table containing the functionalities of the tokens. The key is stored in memory, separate from the software. The key may be encrypted for added security. When an authorized user seeks to run the software, the key is recalled from memory and decrypted, if previously encrypted. The corresponding functionalities indicated by the key are substituted in the software whenever tokens are encountered.

It is another objective of this invention to define a method of securing software by means of programming new CPU instructions during run-time.

It is yet another objective of this invention to define a method of securing software by means of emulating programming of new CPU instructions during run-time.

It is yet another objective of this invention to provide a method of securing software by replacing critical memory addresses used to control flow of a software program with placeholders.

Software programs are a collection of central processing unit (CPU) instructions and data values. During execution of a software program, CPU instructions are executed by a computer's CPU and data values are accessed and generated. CPU instructions are a collection of predefined logical operations a CPU can perform. Each CPU instruction has a unique numerical value distinguishing it from other CPU instructions. Software programs are comprised of those instructions' identifiers followed by data values as arguments for each instruction. This makes CPU instructions a critical part of a software program, without which the software program will not function properly.

According to an embodiment of the present invention, original CPU instructions from a software program are replaced with placeholders, which are numerical values outside the value range of CPU instruction identifiers. Because the values replacing those CPU instructions are not part of the CPU instruction set, the software program is rendered useless unless the CPU is instructed what those new values mean.

According to one embodiment of the invention, the system will use a feature available in CPU to add new instructions to its instruction set by way of special CPU programming. A software program protected by this invention will program a CPU to add new instructions for the corresponding placeholders (or “tokens”) replacing the original CPU instructions. The part of the software that programs the CPU is not subject to the process of instruction replacement. The CPU programming phase does not include the correlation between the different place holders and the functionalities they replace (in other words, what were the original instructions replaced by those place holders). The correlation is stored within a data structure external to the software program. This data structure is relatively small and can be distributed separately from the software program. For further security, in an implementation of the invention, this data structure may be encrypted. Since execution of CPU instructions is performed internally in CPU and can not be reverse engineered or “debugged,” a hacker will not be able to study or reverse engineer the functionality of the placeholders to discover what CPU instructions they are replacing.

According to another embodiment of this invention, software emulation is used instead of CPU programming. In this embodiment, utility code capable of performing different computer operations is executed whenever a program reaches a place holder (token). This utility code will perform a specific and predefined operation as defined in a data structure external to the software program. Since determination of what operation utility code will perform for each place holder (token) is done according to an external data structure (which may optionally be encrypted), reverse engineering of the software program will not reveal the intended functionality of the place holders (tokens).

According to another embodiment of this invention, the data structure used to define the functionality of the place holders (tokens) is to be used as a verification structure, preferably encrypted with a key unique to the computer. The presence of the verification structure in the computer means that the particular computer is authorized to use the software.

According to yet another embodiment of the invention, a memory address critical to proper execution of the software program is replaced with a placeholder. Software programs may be considered to be comprised of vectors of execution code. From time to time, a software program may use a memory address to point to a next step of an execution vector that is not sequential to the preceding execution steps. Examples in which this occurs include JMP (jump), CALL, and GTO (go to) types of instructions. Removal of such a memory address makes the software program useless. The removed memory address may be stored in a data structure external to the software program.

During execution time, whenever the software program encounters a place holder for such a memory address (an entry point memory address), it will use the memory address stored in the external data structure instead of the placeholder to redirect the execution vector to the next execution step in the memory address retrieved from the data structure. In order to make reverse engineering of the process in run time more difficult, a technique known as asynchronous procedure call (APC) may be employed for the purpose of the redirection operation. Using APC, which is an operating system feature, makes the actual redirection operation occur behind the scenes by the operating system, thus making it more difficult for a hacker to reverse engineer the process and overcome it.

In still another embodiment of the invention, a data structure storing definitions for CPU instructions and a data structure storing entry point values may be combined together for purposes of saving memory space and providing additional security. This may be achieved by computing a checksum value of one data structure with the other and embedding this value in the software program. This makes the second data structure redundant, since using the checksum value and the first data structure permits the determination of the value of the second data structure. Since the checksum value is useless without the presence of first data structure, security of the system is not compromised.

The invention may be embodied, for example, as a method or as software (on a computer-readable medium) or a computer system implementing the method.

### BRIEF DESCRIPTIONS OF THE DRAWINGS

The invention will now be described in further detail in connection with the attached drawings, in which:

FIG. 1 represents a pictorial description of a software program;

FIGS. 2A and 2B depict examples of prior art authorization logic for use of a software program like that depicted in FIG. 1;

FIG. 3 describes a key for use in embodiments of the invention;

FIG. 4 shows a flow chart describing a process according to an embodiment of the invention by which software program code may be converted into protected code;

FIG. 5 shows a flow chart describing a process according to an embodiment of the invention by which a process implemented in unprotected code may be used when a user requests access to protected code;

FIG. 6 shows a flow chart describing a process according to an embodiment of the invention by which code protected by the process depicted in FIG. 4 may be executed;

FIG. 7 shows a flow chart describing a software-emulated embodiment of the process described in FIG. 6; and

FIG. 8 shows an example of a software process that may be used in one of the steps shown in the process depicted in FIG. 4.

### DETAILED DESCRIPTION OF EMBODIMENTS OF THE INVENTION

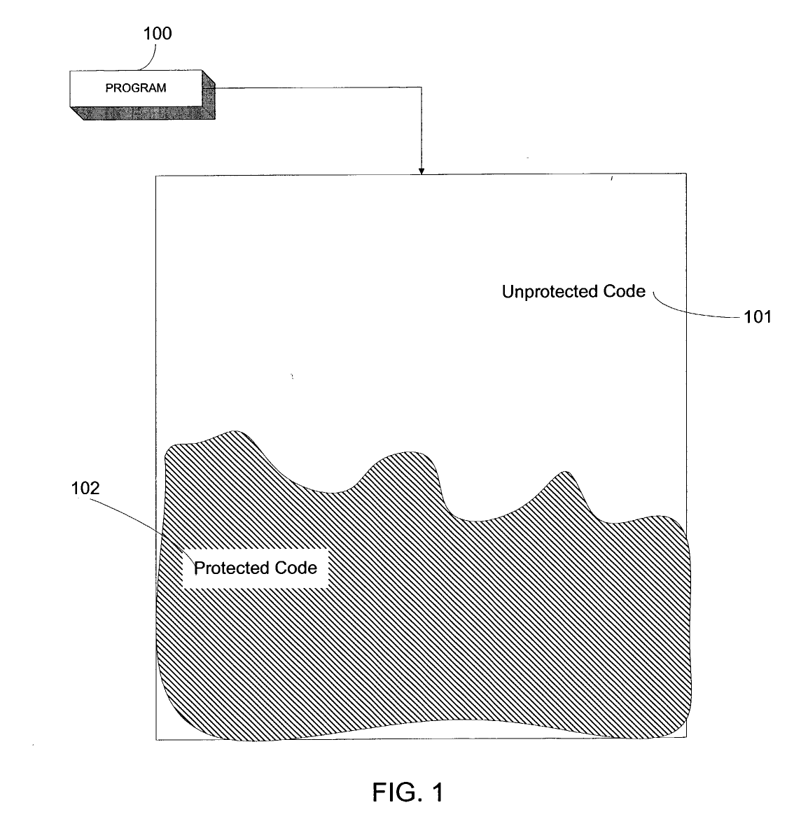

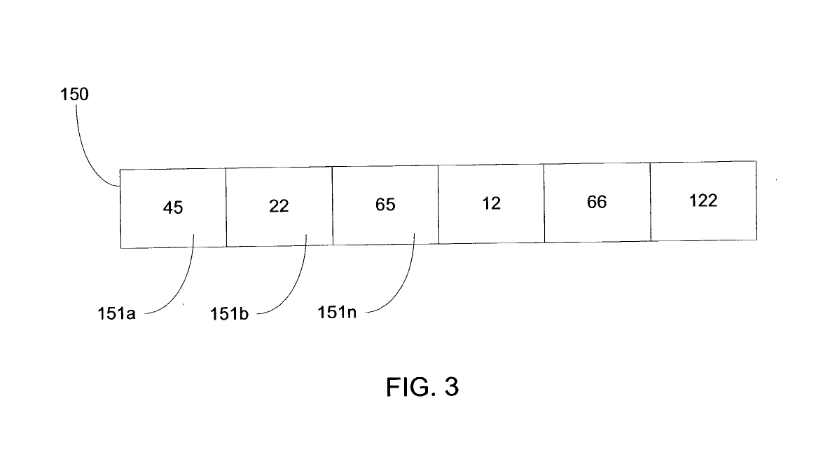

FIG. 3 shows an exemplary detail of a key 150, which is a verification structure that contains definitions 151a, 152b . . . n for tokens. As mentioned above, tokens are logical symbols that replace computer instructions in the software program in order to provide protection. The functionality of a token is defined in key 150. For example, value 151a defines what functionality a first token will perform for a specific program, say, program 100 of FIG. 1. Functionality (defined by the “number” shown in the box for, say, value 151a) may be a computer language operator, for example, “Add,” or a system function, for example, “Compare String.” When program 100 executes, key 150 must be present in order for protected code 102 to function properly. As program 100 executes, it sequentially accesses the values in key 150 to determine the functionalities of tokens in protected code 102; however, in other embodiments, the order of access need not be sequential. For example, the tokens may be interleaved in some predetermined fashion (and deinterleaved upon program execution) in order to provide security (for example, the first token to be inserted may be the fourth one in the key, the second token to be inserted may be the first one, etc., according to some predetermined algorithm). In order to further enhance security, key 150 may be encrypted with a cryptographic key to bind it to a specific computer.

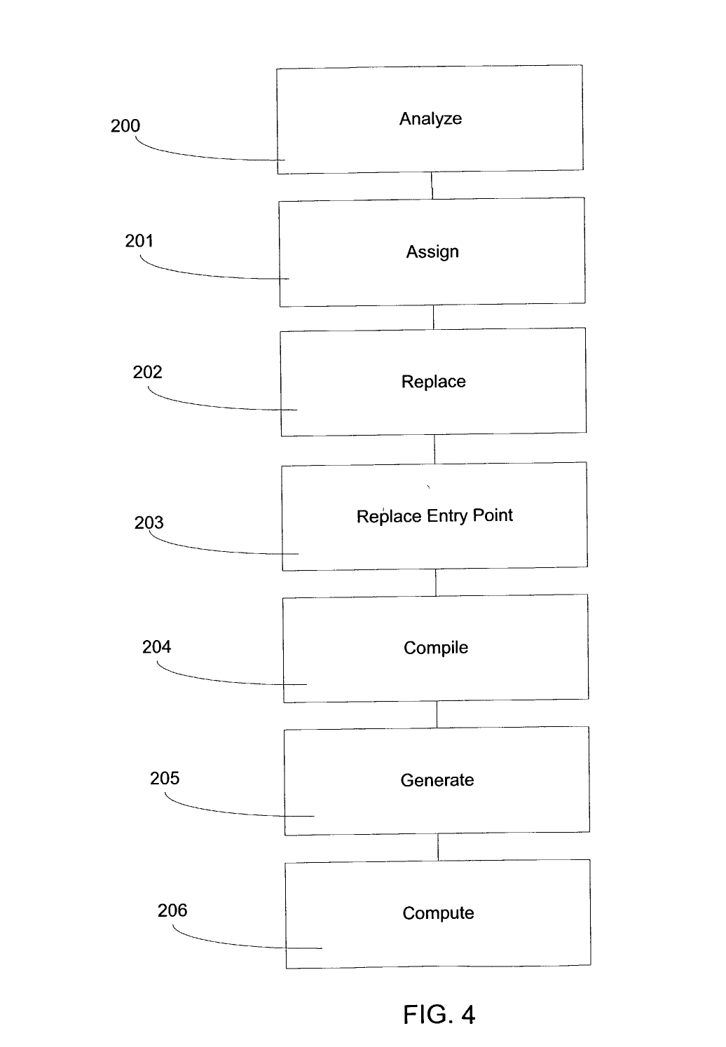

FIG. 4 contains a flowchart of an exemplary process to convert parts of program 100 code into protected code 102. The first step of the process is an analysis step “Analyze” 200. In Step 200, the source code of program 100 is identified for which parts of it are to be protected code 102 and which are not to be protected 101. Non-protected code 101 may be functionality to be offered free to attract customers to use the program 100. For example, this could be functionality of a word processor allowing a user to edit documents. In this example, protected code 102 could be functionality to save those edited documents.

Step 201, “Assign,” involves arbitrarily assigning different tokens to operators and/or system functions. In one example, Step 201 could assign operator “add” to token 151a, and system function “compare string” to token 151b.

Step 202 “Replace” involves replacing all operators and/or functions for which tokens were assigned in Step 201, and which are included within protected code 102, the tokens assigned in Step 201. In one embodiment of the invention, this may be performed by replacing operators with a function call to a generic function that executes tokens, and passes as parameters the appropriate token ID and the arguments originally used with the operator.

In another embodiment of the invention, Step 202 is accomplished at the object code level. Computer instructions in an object file created by a compiler are replaced with new dummy computer instructions, so each token has a new instruction assigned to it. New instructions are instructions that are not part of the CPU original instruction set during time of the CPU's manufacturing. Those new instructions are then programmed in the CPU during execution of program 100 to perform functionalities defined in key 150 for different tokens. For example, consistent with the example above, token 151a may be assigned to perform “Add” functionality. Therefore, a computer instruction “Add” in the object code of protected code 102 will be replaced with token 151a. During execution, new instructions corresponding to tokens 151a, 151b . . . n will be programmed into the CPU with corresponding functionality as defined in key 150.

One method to achieve this programming of instructions into the CPU is to use a CPU feature known as “micropatching.” Micropatching allows post-production programming of CPU microcode via software means. This feature is commonly used by CPU manufacturers to correct malfunctions in CPUs and for debugging purposes.

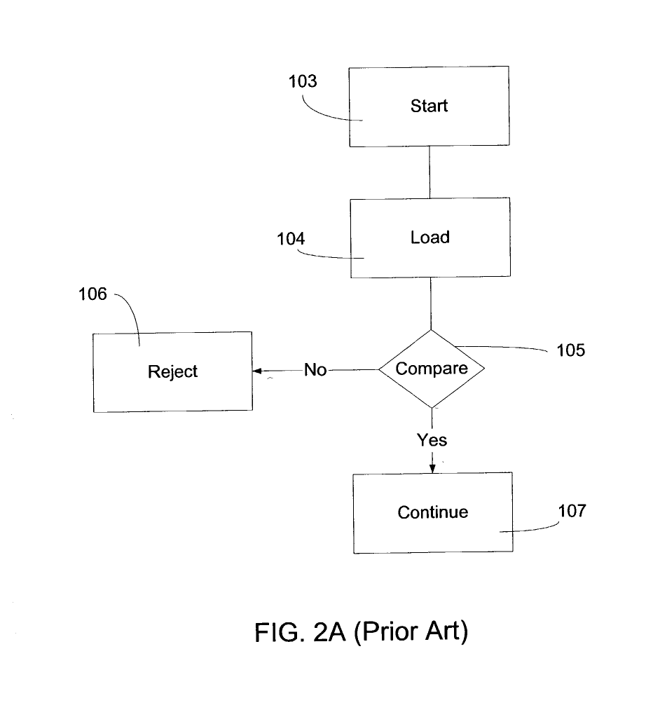

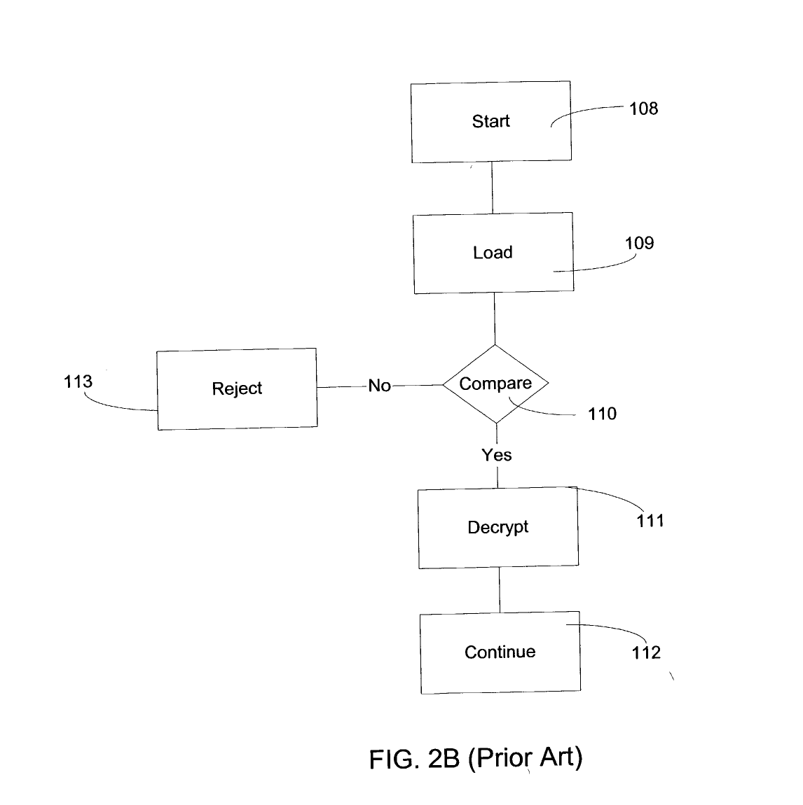

In Step 203, “Replace Entry Point,” the entry point memory addresses of protected code 102 are replaced with respective tokens. An entry point address is a memory address used by program 100 to redirect execution of the code to protected code 102. For program 100 to be able to execute protected code 102, the entry point address must be present in memory during the time of execution. For example, referring back to FIGS. 2A and 2B, entry point addresses are used by prior art resume execution blocks 112 and 107. Thus, entry point addresses are necessary for proper execution of program 100. Replacing the entry point addresses with tokens makes an attack on either of decision blocks 105 or 110 useless, for the code will not have the sufficient data to perform redirection to protected code 102.

In Step 204, “Compile,” the source code of program 100 is converted into computer instructions, i.e., object code, typically using a commercial software compiler.

In Step 205, “Generate,” all token definitions defined in Step 201 are assembled into one data structure, thus forming key 150. The result of this process is that all data needed to properly execute protected code 102 is contained in key 150. As discussed above, key 150 may be further protected, making unauthorized access to protected code 102 even more difficult.

Step 206, “Compute,” involves computing a value X from key 150 and entry point Z. Entry point Z was defined in Step 203. For example, a mathematical function Fn can be used to compute X=Fn(Entry Point Z, Key 150). Value X is then to replace the entry point token specified in Step 203. Once this has been done, in order to derive the correct entry point address to protected code 102 during run-time, key 150 would have to be present in memory in order to properly calculate Entry Point Address Z=Fn(X, Key 150).

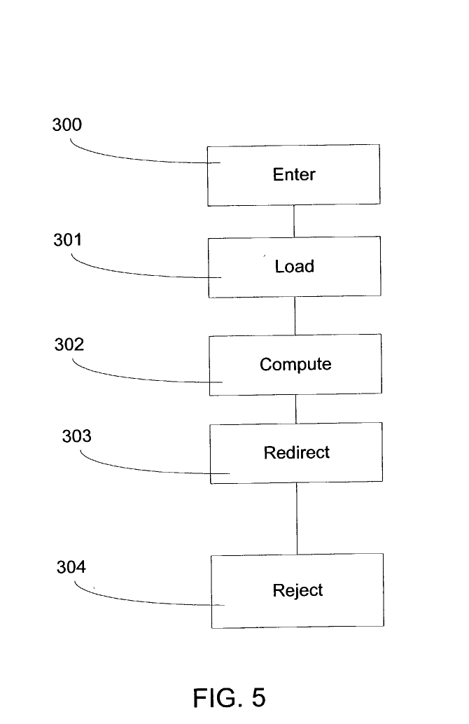

FIG. 5 is directed to the process that occurs when a user desires to execute a protected code 102 included in a program 100 and protected by the above-described methods. In particular, FIG. 5 describes a process implemented in unprotected code 101 that may be executed when a user requests access to protected code 102. In Step 300, “Enter,” a user has indicated to program 100 a desire to execute functionality that is part of protected code 102. In Step 301, “Load,” program 100 locates key 150 in non-volatile memory used for storage and places a copy of it in memory. In one embodiment of the invention described above, key 150 may be encrypted with information providing unique identification of the computer. If so, Step 301 will also decrypt key 150 to convert it to its original form, as formed in Step 205.

Step 301 is followed by Step 302, “Compute,” in which Entry Point Z=Fn(X, key 150) is calculated, where X is a value computed in Step 206. As discussed above, value X is embedded within program 100 in unprotected code 101. Those skilled in the art will readily appreciate that key 150 must be present in memory in order to properly calculate Entry Point Z.

Step 303, “Redirect,” uses computed entry point Z, which is the memory address where protected code 102 begins, to alter the execution path of program 100, so the next step of the execution path will be the first instruction of protected code 102, which resides in memory address Z. Step 303 is dependent on the value Z being successfully computed in Step 302. If value Z was not successfully computed in Step 302, Step 303 will not redirect the execution path to protected code 102. This situation occurs, for example, in the case in which key 150 is not present, therefore making it impossible to properly compute value Z in Step 302. In such cases (i.e., where the redirection of Step 303 fails), the process will proceed to Step 304, “Reject,” in which the user is informed that his attempt to access functionality of protected code 102 was denied.

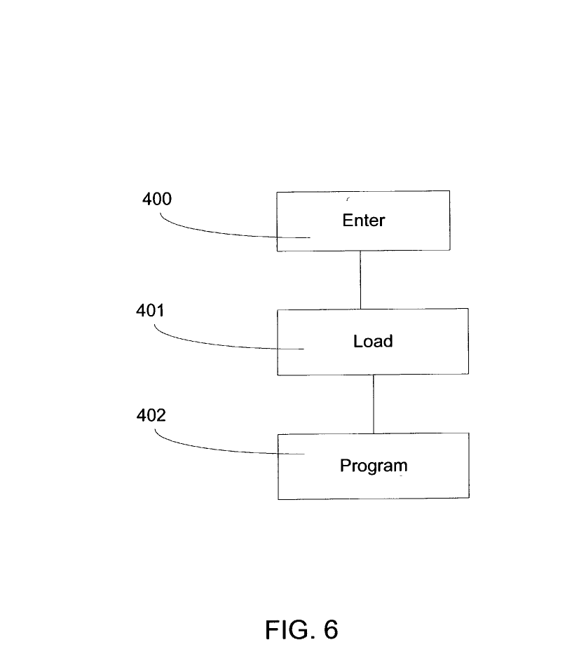

FIG. 6 describes one embodiment for run-time processing to execute protected code 102 altered by an embodiment of the invention described in connection with FIG. 4. This embodiment relies on the capabilities of a CPU to be programmed with new CPU instructions by software means. CPU instructions are a series of primitive computer logic operations built into the architecture of a CPU. In recent years, CPU manufacturers have built functionality into CPUs to reprogram existing CPU instructions or to add new ones by software means (i.e., “micropatching”). Before this functionality existed, post-production changes to CPU instructions were impossible. An example of this type of functionality is Intel Corporation's Micropatching DFT feature in its Pentium® family of processors.

Returning to FIG. 6, Step 400, “Enter,” is executed when a user attempts to use functionality of program 100 that is part of protected code 102, which, in order to be run, requires a valid key 150 to be present in memory. Step 400 may be reached by a redirect in Step 303 of FIG. 5.

In Step 401, “Load,” program 100 locates key 150 in non-volatile memory used for storage and places a copy of it in memory. In one of the above-described embodiments, key 150 may be encrypted with information providing unique identification of the computer. If so, Step 401 also involves decrypting key 150 to convert it back to its original form as formed in Step 205.

In Step 402, “Program,” CPU instructions are added and/or modified so that tokens inserted into protected code 102 in Step 202 will be recognized as valid CPU instructions when protected code 102 is executed. The particular functionality that Step 402 will program for each new instruction for each token is determined by values in key 150. For example, value 151a may determine the functionality of Token 1. Value 151a may be an index in a library of a predetermined set of operators, as used in Step 205. For example, value 151a equaling 1 may mean that Token 1 is an ADD operator. Therefore, Step 402 will add a CPU instruction for token 1 that performs an addition operation. Step 402 makes tokens recognizable by the CPU as valid CPU instructions that can be executed. For each program 100, tokens typically have different meanings determined based on the contents of a key 150. Therefore, across different programs the same token may have different functionality in run-time, since program 100 does not contain the definitions of those tokens; rather, those definitions are contained in key 150, which is not part of Program 100. As a result, reverse engineering of program 100 to study tokens' functionalities is impossible.

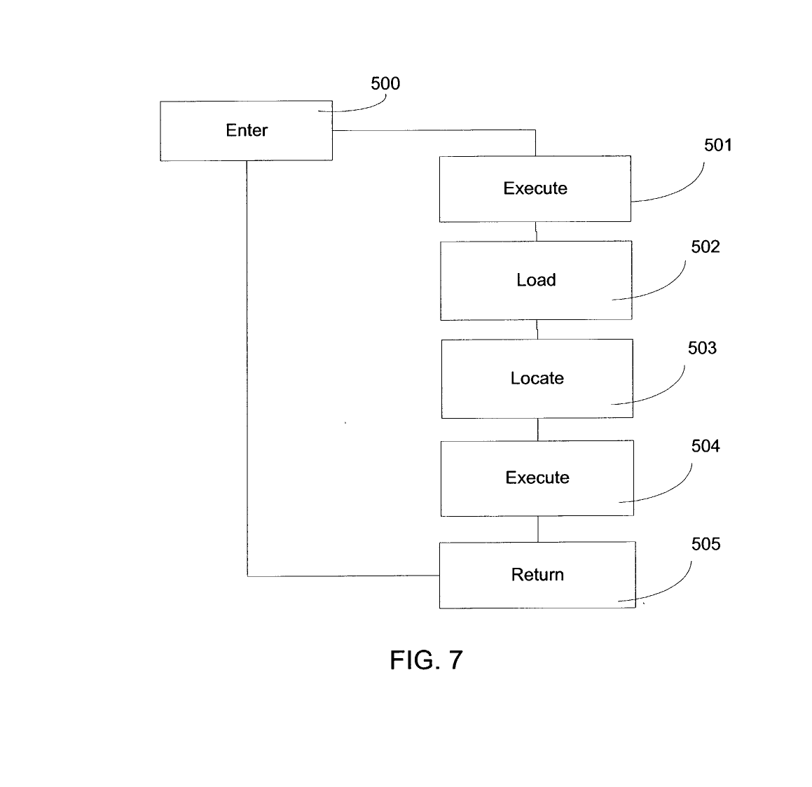

FIG. 7 describes a software-emulated embodiment of the run-time process described in FIG. 6. In this embodiment, no CPU programming is performed.

In Step 500, “Enter,” a user is attempting to use functionality of program 100 that is part of protected code 102, and which requires a valid key 150 to be authorized to execute. Step 500 may be reached via redirection in Step 303.

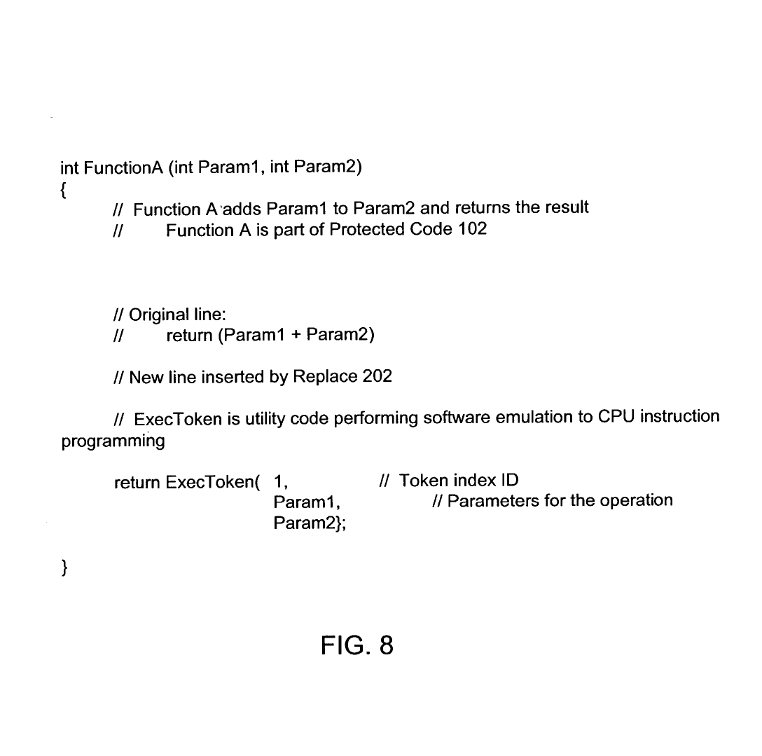

In Step 501, “Execute,” the execution path in protected code 102 has encountered a token inserted into the code in Step 202. In this embodiment, Step 202 may also insert a redirection code to execute a software emulator that executes functionality matching the token definition (see FIG. 8, for example). Step 501 may also pass in parameters for the operation to be performed for this token, if needed.

In Step 502, “Load,” program 100 locates key 150 in non-volatile memory used for storage and place a copy of it in memory. In one above-described embodiment, key 150 may be encrypted with information providing unique identification of the computer. If so, Step 502 also decrypts key 150 to convert it back to its original form, as formed in Step 205.

In Step 503, “Locate,” the corresponding value of the token being executed, e.g., 151n, is located in key 150. For example, if Token 1 is about to be executed, Step 503 will locate the value in position 151a. Of course, should an interleaving algorithm have been used, as discussed above, the actual position within key 150 that contains the first token (Token 1) is located, and its value is used.

In Step 504, “Execute,” the functionality as defined in by the corresponding token value (e.g., 151a, in the example above) is executed. The value in Value 151a may be an index to a predefined set of computer operations. Note that, since key 150 is constructed for each particular program 100, a value in a particular position within key 150 may correspond to an entirely different functionality across different programs. As a result, even in the unlikely event that a hacker does gain access to a particular key 150, it is useless for programs other than the particular program for which it was constructed.

Finally, Step 505, “Return,” leads the program execution path back to the point in code where Step 500 was triggered, and execution of protected code 102 resumes. Step 505 may also return results of operations on parameters supplied by Step 501 to protected code 102, in appropriate cases.

The various embodiments of the invention may be utilized in a number of ways. In a first exemplary implementation, an embodiment of the invention may be incorporated into the method described in U.S. Pat. No. 6,411,941, co-assigned and incorporated herein by reference in its entirety. That is, for example, an original equipment manufacturer (OEM) may install software in a computer system it manufactures, where the software has tokens inserted according to an embodiment of the present invention. The OEM would further store in non-volatile memory of the computer system's BIOS the required key for each software program installed on the computer system. Note that this exemplary implementation is not necessarily limited to an OEM but is also applicable to any entity that is capable of installing software and programming a key into non-volatile memory of the BIOS.

In a variation on the first exemplary embodiment, the key need not necessarily be stored in non-volatile memory of the BIOS. It may alternatively be stored in any memory location of the computer system that is not the same location as the software itself. This may be, for example, a different portion of a hard disk, a different hard disk, a separate CD-ROM, DVD-ROM, or floppy disk to be inserted into a disk drive, or any computer-readable medium usable with the computer system.

In a second exemplary embodiment, a consumer may purchase (or otherwise obtain) a software package, which contains instructions as to how to then obtain the key. The consumer may then obtain the key and store it according to the instructions. This may be done, for example, by having the consumer download the key from a web site, send for a separate computer-readable medium, or perform any other procedure for obtaining the key. In general, a secure method of transmission is preferable, to maintain the security of the key.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A method of providing software security, the software comprising program code, the method comprising the steps of:
replacing at least one portion of program code with a corresponding at least one token;
creating a key in which the at least one token is associated with an indication of functionality of the at least one portion of program code replaced by the at least one token; and
storing the key in memory separate from the software.

2. The method according to claim 1, further comprising the step of:
encrypting the key using information identifying a particular computer on which the software is authorized to be run.

3. The method according to claim 1, wherein the at least one portion of program code and the at least one token comprise a plurality of portions of program code and a plurality of tokens, and wherein the step of creating a key comprises the step of:
interleaving the positions of the indications of functionalities corresponding to the tokens such that they do not correspond in order to the order in which the tokens are substituted for portions of program code in the step of replacing.

4. The method according to claim 1, wherein the step of replacing comprises the steps of:
compiling the software to produce object code;
performing the replacing within the resulting object code, wherein each token represents a new instruction not included in a standard instruction set of a CPU for which the object code was produced; and
programming the CPU such that each new instruction will be recognized as a valid CPU instruction.

5. The method according to claim 1, wherein the step of replacing comprises the steps of:
replacing at least one operator within the program code with a function call to a generic function that executes tokens and passes as parameters an appropriate token identifier and any arguments originally used with the operator.

6. The method according to claim 1, wherein the at least one portion of program code comprises at least one of an operator and a system function.

7. The method according to claim 1, further comprising the step of:
replacing at least one entry point memory address of at least one portion of the software intended to be protected with at least one corresponding entry point token.

8. The method according to claim 7, further comprising the steps of:
computing at least one value using the key and at least one entry point; and
replacing the at least one corresponding entry point token with the at least one value.

9. A method of executing a portion of the software protected according to the method of claim 8, comprising the steps of:
loading the key into memory;
computing at least one entry point based on the at least one value; and
redirecting execution of the software to the computed entry point.

10. A method of executing a portion of the software protected according to the method of claim 1, comprising the steps of:
loading the key into memory; and
substituting for at least one token in the portion of the software at least one functionality indicated by the key as corresponding to the at least one token.

11. A method of executing a portion of the software protected according to the method of claim 2, comprising the steps of:
loading the key into memory;
decrypting the key to produce a decrypted key; and
substituting for at least one token in the portion of the software at least one functionality indicated by the decrypted key as corresponding to the at least one token.

12. A method of executing a portion of the software protected according to the method of claim 3, comprising the steps of:
loading the key into memory;
de-interleaving the key; and
substituting for at least one token in the portion of the software at least one functionality indicated by the de-interleaved key as corresponding to the at least one token.

13. A method of executing a portion of the software protected according to the method of claim 4, comprising the steps of:
loading the key into memory; and
substituting for at least one token in the portion of the software at least one corresponding CPU instruction indicated by the key as corresponding to the at least one token.

14. A method of executing a portion of the software protected according to the method of claim 4, comprising the steps of:
loading the key into memory; and
executing, when at least one token in the portion of the software is detected, a software emulator that executes at least one functionality, as indicated by the key, defined as corresponding to the at least one token.

15. The method according to claim 1, wherein the step of storing the key in memory separate from the software comprises the step of:
storing the key in non-volatile memory of a BIOS.

16. The method according to claim 1, wherein the step of storing the key in memory separate from the software comprises the step of:
storing the key on a computer-readable medium different from that on which the software is stored.

17. A method of providing secure software, the software comprising program code, the method comprising the steps of:
replacing at least one portion of program code with a corresponding at least one token;
creating a key in which the at least one token is associated with an indication of functionality of the at least one portion of program code replaced by the at least one token;
providing the software to a user; and
separately providing the key to the user for storage separately from the software.

18. The method according to claim 17, wherein the step of separately providing the key comprises the step of:
providing instructions to the user for downloading the key and storing it separately from the software.

19. The method according to claim 17, wherein the step of separately providing the key comprises the step of:
providing the user with a computer-readable medium containing the key, where the computer-readable medium is separate from any computer-readable medium on which the software is stored.
